(19) United States
(12) Patent Application Publication
(10) Pub. No.: US 2019/0285923 A1
(43) Pub. Date: Sep. 19, 2019

(54) CHOLESTERIC LIQUID CRYSTAL WRITING BOARD

(71) Applicant: IRIS OPTRONICS CO., LTD., Tainan City (TW)

(72) Inventors: Chi-Chang LIAO, Tainan City (TW); Shu-Shien LIU, Tainan City (TW); Tsung-Ming PAI, Tainan City (TW); Fu-Ming WANG, Tainan City (TW)

(21) Appl. No.: 15/966,440

(22) Filed: Apr. 30, 2018

(30) Foreign Application Priority Data
Mar. 14, 2018 (TW) 107108729

(51) Int. Cl. G02F 1/1333; G02F 1/1343; G06F 3/03

(52) U.S. Cl. CPC G02F 1/13338; G02F 1/13439; G02F 2203/02; G06F 3/0304; G02F 2201/08; G02F 1/133345

(57) ABSTRACT

A cholesteric liquid crystal writing board comprises a cholesteric liquid crystal device, a photo-sensing array layer and a sensing-signal processing circuitry. The cholesteric liquid crystal device comprises a cholesteric liquid crystal layer, and has a light-entering surface and a light-emitting surface opposite to the light-entering surface. The photo-sensing array layer comprises a plurality of photo-sensing elements arranged in an array. The photo-sensing array layer is disposed on one side of the light-emitting surface of the cholesteric liquid crystal device. When at least a portion of the cholesteric liquid crystal layer is morphologically changed due to a pressure caused by a press to generate a luminous flux change, one of the photo-sensing elements of the photo-sensing array layer senses the luminous flux change and generates a sensing signal accordingly. The sensing-signal processing circuitry coupled to the photo-sensing array layer receives the sensing signal and accordingly outputs position data of the light-sensing element in the photo-sensing array layer.

### CROSS REFERENCE TO RELATED APPLICATIONS

This Non-provisional application claims priority under 35 U.S.C. § 119(a) on Patent Application No(s). 107108729 filed in Taiwan, Republic of China on Mar. 14, 2018, and the entire contents of which are hereby incorporated by reference.

### BACKGROUND OF THE INVENTION

### Field of Invention

The invention relates to a cholesteric liquid crystal writing board, and more particularly to a cholesteric liquid crystal writing board capable of detecting a writing position and outputting writing position data.

### Related Art

In cholesteric liquid crystals, chiral dopants are added to nematic liquid crystals to make the liquid crystal molecules to have a helical arrangement structure, and two different arrangement states of liquid crystal molecules rendering reflection and penetration under various voltage differences are utilized to achieve different light transmission rates to achieve the display effect. The principle is that, when a low voltage or a high voltage is externally applied, the liquid crystal molecules may be transformed into the focal conic state or the homeotropic state from the planar state, respectively. When the cholesteric liquid crystal molecules are in the planar state, part of the incident light is reflected to show a color. When the cholesteric liquid crystal molecules are in the focal conic state, most of the incident light pass through those molecules and a small portion thereof is scattered. When the cholesteric liquid crystal molecules are in the vertical state, the incident light may pass through those molecules completely.

The planar state and the focal conic state are both stable states. When the applied voltage is turned off and disappears, the state of the molecules and the displayed images stay. The voltage is only applied when the state of the cholesteric crystal liquid molecules need to be changed to another state and when the displayed images need to be refreshed. Its properties, such as low power-consumption and the memorability, also make the cholesteric liquid crystals become the first choice for e-books. In addition, this display mechanism is less affected by the gap between the upper and lower plates, and potentially can be applied in a bistable flexible display. Compared with other types (e.g. TN-type) of liquid crystal displays, the cholesteric liquid crystal display has the advantages of power saving, colorful display, light-adjusting, and the ability to be applied in a bistable flexible display, which contribute to its wide application.

### SUMMARY OF THE INVENTION

In view of the foregoing objectives, a cholesteric liquid crystal writing board that can be used in interactive writing systems, such as interactive teaching, interactive meeting and the like, is provided. For the cholesteric liquid crystal writing board of this disclosure, it is to utilize the property of the cholesteric liquid crystal. In addition to achieving power-saving, the writing position may also be obtained. Hence, the application of the cholesteric liquid crystal writing board can be expanded, and the advantages and objects of low-cost and simultaneously interaction can be achieved.

To achieve the above objective, a cholesteric liquid crystal writing board according to the present disclosure comprises a cholesteric liquid crystal device, a photo-sensing array layer, and a sensing-signal processing circuitry. The cholesteric liquid crystal device comprises a cholesteric liquid crystal layer and having a light-entering surface and a light-emitting surface opposite to the light-entering surface. The photo-sensing array layer comprises a plurality of photo-sensing elements arranged in an array, and is disposed on one side of the light-emitting surface of the cholesteric liquid crystal device. When at least a portion of the cholesteric liquid crystal layer is morphologically changed due to a pressure caused by a press to generate a luminous flux change, one of the photo-sensing elements of the photo-sensing array layer senses the luminous flux change and generates a sensing signal accordingly. The sensing-signal processing circuitry is coupled to the photo-sensing array layer, and receives the sensing signal and accordingly outputs position data of the light-sensing element in the photo-sensing array layer.

In one embodiment, the cholesteric liquid crystal device further comprises a first substrate and a second substrate opposite to the first substrate. The cholesteric liquid crystal layer is disposed between the first substrate and the second substrate. The cholesteric liquid crystal device further comprises a first transparent electroconductive layer disposed on a surface of the first substrate facing toward the cholesteric liquid crystal layer, and the cholesteric liquid crystal device further comprises a second transparent electroconductive layer disposed on one side of the second substrate facing toward the cholesteric liquid crystal layer.

In one embodiment, the second transparent electroconductive layer is comprehensively disposed on the one side of the second substrate facing toward the cholesteric liquid crystal layer.

In one embodiment, the second transparent electroconductive layer comprises a plurality of electrode blocks respectively disposed in correspondence with the photo-sensing elements which are arranged in the array.

In one embodiment, the cholesteric liquid crystal device further comprises an insulating layer. The second transparent electroconductive layer, the insulating layer and the photo-sensing array layer are sequentially stacked on a surface of the second substrate facing toward the cholesteric liquid crystal layer.

In one embodiment, the photo-sensing array layer is disposed on a surface of the second substrate opposite to the cholesteric liquid crystal layer in a back-to-back manner.

In one embodiment, the photo-sensing array layer is disposed on one side of the second substrate opposite to the cholesteric liquid crystal layer, the photo-sensing array layer comprises a third substrate, and the photo-sensing elements which are arranged in the array are disposed on a surface of the third substrate facing toward the second substrate.

In one embodiment, the cholesteric liquid crystal writing board further comprises a backing plate which is disposed on one side of the second substrate facing toward the light-emitting surface, and the backing plate is a light-absorbing plate.

In one embodiment, the cholesteric liquid crystal writing board further comprises a backing plate which is disposed on one side of the second substrate facing toward the light-emitting surface, and the backing plate is a light-reflecting plate.

In one embodiment, the first substrate is a transparent substrate, and the second substrate is a light-absorbing substrate.

In one embodiment, the first substrate is a transparent substrate, and the second substrate is a light-reflecting substrate.

In one embodiment, each of the first substrate and the second substrate is a transparent substrate, and the third substrate is a light-absorbing substrate.

In one embodiment, each of the first substrate and the second substrate is a transparent substrate, and the third substrate is a light-reflecting plate.

In one embodiment, the photo-sensing array layer further comprises a plurality of upload-lines and a plurality of read-lines which are disposed crossed to the upload-lines to define a plurality of photo-sensing dot-areas. Each of the photo-sensing dot-areas comprises a switch element and one of the photo-sensing elements. A control terminal of the switch element is connected to one of the upload-lines. A first terminal of the switch element is connected to one of the read-lines. A second terminal of the switch element is connected to one terminal of the aforementioned photo-sensing element, and the other terminal of the aforementioned photo-sensing element is connected to a reference voltage.

In one embodiment, the sensing signal is transmitted to another electronic device when the upload-lines are turned on.

In one embodiment, the sensing signal is transmitted to another electronic device in a blanking time after the upload-lines are turned on.

In one embodiment, the cholesteric liquid crystal writing board further comprises a control unit, a communication unit, and a memory unit. The communication unit is electrically connected to the control unit, and the cholesteric liquid crystal writing board communicates and links with an electronic device through the communication unit. The memory unit is electrically connected to the control unit and stores the sensing signal.

In one embodiment, when the cholesteric liquid crystal device is pressed, the at least one portion of the cholesteric liquid crystal layer is morphologically changed from the focal conic state to the planar state.

In one embodiment, the cholesteric liquid crystal device is pressed to generate a writing track, and the writing track renders a color corresponding to the cholesteric liquid crystal device.

In one embodiment, the position data comprises a position information concerning where the cholesteric liquid crystal device is pressed.

As mentioned above, in the cholesteric liquid crystal writing board according to the present disclosure, the cholesteric liquid crystal device comprises a cholesteric liquid crystal layer and the photo-sensing array layer which comprises a plurality of photo-sensing elements arranged in an array is disposed on one side of the light-emitting surface of the cholesteric liquid crystal device. When at least a portion of the cholesteric liquid crystal layer is morphologically changed due to a pressure caused by a press to generate a luminous flux change, the photo-sensing element(s) in the photo-sensing array layer may sense this luminous flux change and generate a sensing signal accordingly. The sensing-signal processing circuitry is coupled to the photo-sensing array layer, and may receive the sensing signal and accordingly output position data of the light-sensing element in the photo-sensing array layer. Hence, the cholesteric liquid crystal writing board utilizes the property of the cholesteric liquid crystal, so as to achieve the objective of power-saving and the objective of obtaining the writing position. Accordingly, the application of the cholesteric liquid crystal writing board can be expanded, such as interactive teaching, interactive meeting and the like, and the advantages and objects of low-cost and simultaneously interaction can be achieved.

### BRIEF DESCRIPTION OF THE DRAWINGS

The embodiments will become more fully understood from the detailed description and accompanying drawings, which are given for illustration only, and thus are not limitative of the present invention, and wherein:

FIG. 1 is a schematic application view showing an embodiment of a cholesteric liquid crystal writing board of this disclosure.

FIG. 2A is a partially-exploding stereoscopic schematic view showing an embodiment of the cholesteric liquid crystal writing board of this disclosure.

FIG. 2B is a structural schematic view showing the cholesteric liquid crystal writing board of FIG. 2A upon being pressed.

FIG. 2C is a schematic circuit diagram showing a light-sensing point of a photo-sensing array layer of the cholesteric liquid crystal writing board of FIG. 2B.

FIG. 2D is a schematic view showing the incident light incident to the cholesteric liquid crystal writing board of FIG. 2B.

FIG. 2E is a schematic structure view showing another embodiment of the cholesteric liquid crystal writing board of this disclosure.

FIG. 3 is a structural schematic view showing another embodiment of the cholesteric liquid crystal writing board of this disclosure.

FIG. 4 is a structural schematic view showing another embodiment of the cholesteric liquid crystal writing board of this disclosure.

FIG. 5 is a structural schematic view showing still another embodiment of the cholesteric liquid crystal writing board of this disclosure.

FIG. 6 is a structural schematic view showing yet still another embodiment of the cholesteric liquid crystal writing board of this disclosure.

FIG. 7 is a functional block diagram showing an embodiment of the cholesteric liquid crystal writing board and an electronic device of this disclosure.

### DETAILED DESCRIPTION OF THE INVENTION

The embodiments of the invention will be apparent from the following detailed description, which proceeds with reference to the accompanying drawings, wherein the same references relate to the same elements.

It is to be noted that all directional indications (such as up, down, left, right, front, rear and the like) in the embodiments of the present disclosure are only used for explaining the relative positional relationship, circumstances during its operation, and the like, between the various components in a certain specific posture (as shown in the accompanying drawings). If the specific posture changes, the directional indication will also change accordingly.

The cholesteric liquid crystal writing board provided in the embodiments of the present disclosure can be written with texts or drawn with an image on the writing surface thereof, and can be applied to, for example but without limiting to, mobile phones, tablets, electronic whiteboards, or other display devices that can display images. In some embodiments, the writing/drawing images of the cholesteric liquid crystal writing board provided in the embodiments of the present disclosure may be displayed on other electronic devices through a network. Alternatively, the images of other electronic devices may be synchronously displayed on the cholesteric liquid crystal writing board of the present disclosure through the network.

The cholesteric liquid crystal writing boards in the following embodiments are exemplified by large-sized electronic blackboards (or whiteboards) applied to an interactive writing system, such as those used in a conference or a classroom, but the present disclosure is not limited thereto. The cholesteric liquid crystal writing boards provided in the embodiments of the present disclosure utilize the property of cholesteric liquid crystal molecules and are therefore bistable display apparatuses. When the cholesteric liquid crystal writing board displays an image or a frame, no additional power is required, and this image or frame stays as is. Additional power is only required when the cholesteric crystal molecules needs to be changed to another state or the displayed frame(s) needs to be refreshed. Hence, the cholesteric liquid crystal writing board is a relatively power-saving electronic device.

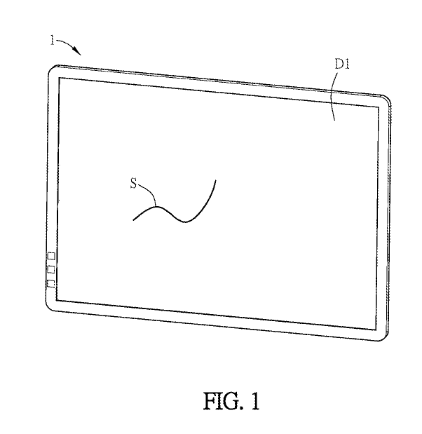

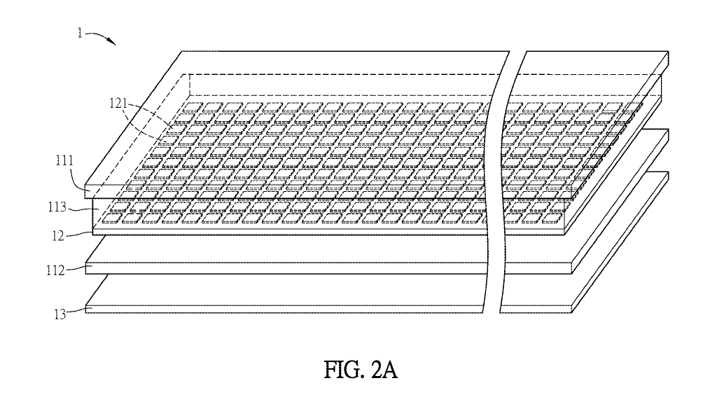

FIG. 1 is a schematic application view showing an embodiment of a cholesteric liquid crystal writing board of this disclosure. FIG. 2A is a partially-exploding stereoscopic schematic view showing an embodiment of the cholesteric liquid crystal writing board of this disclosure. FIG. 2B is a structural schematic view showing the cholesteric liquid crystal writing board of FIG. 2A upon being pressed. FIG. 2C is a schematic circuit diagram showing a light-sensing point of a photo-sensing array layer of the cholesteric liquid crystal writing board of FIG. 2B. FIG. 2D is a schematic view showing the incident light incident to the cholesteric liquid crystal writing board of FIG. 2B.

As shown in FIG. 1, and through FIG. 2A to FIG. 2D, a cholesteric liquid crystal writing board 1 may comprise a cholesteric liquid crystal device 11, a photo-sensing array layer 12 and a sensing-signal processing circuitry C. The photo-sensing array layer 12 comprises a plurality of photo-sensing dot-areas 121 or light-sensing elements 1211 arranged in an array. The cholesteric liquid crystal device 11 comprises a cholesteric liquid crystal layer 113. The cholesteric liquid crystal device 11 has a light-entering surface D1 and a light-emitting surface D2 opposite to the light-entering surface Dl. The light-entering surface D1 of this embodiment is the surface of the cholesteric liquid crystal writing board 1 which faces toward the user, and is also referred to a writing surface or a display surface. In some embodiments, a protective film layer or a protective substrate may be provided on the light-entering surface D1 to protect the cholesteric liquid crystal writing board 1. The photo-sensing array layer 12 is disposed on one side of the light-emitting surface D2 of the cholesteric liquid crystal device 11. When at least a portion of the cholesteric liquid crystal layer 113 is morphologically changed due to a pressure caused by a press to generate a luminous flux change, one or more of the photo-sensing elements 1211 in the photo-sensing array layer 12 may sense the luminous flux change and generate a sensing signal accordingly. The sensing-signal processing circuitry C is coupled to the photo-sensing array layer 12 and may receive the sensing signal and accordingly outputs position data Dp of the aforementioned one or more of the photo-sensing elements 1211 in the photo-sensing array layer 12 when the foregoing situation occurs. The position data Dp comprises position information that the place of the cholesteric liquid crystal device 11 is pressed. Hence, the position of the luminous flux change occurred in the cholesteric liquid crystal device 11 can be determined according to this sensing signal. In other words, the cholesteric liquid crystal writing board 1 may sense where the cholesteric liquid crystal device 11 is pressed.

Hereinafter, the structure of the cholesteric liquid crystal device 11 will be described.

The cholesteric liquid crystal device 11 may comprise a first substrate 111, a second substrate 112 and the cholesteric liquid crystal layer 113. The first substrate 111 is disposed opposite to the second substrate 112, and the cholesteric liquid crystal layer 113 has a plurality of cholesteric liquid crystal molecules (not shown in the drawings) and the cholesteric liquid crystal molecules may be filled between the first substrate 111 and the second substrate 112. The cholesteric liquid crystal device 11 further comprises a first transparent electroconductive layer 114 disposed on a surface of the first substrate 111 facing toward the cholesteric liquid crystal layer 113. The cholesteric liquid crystal device 11 further comprises a second transparent electroconductive layer 115 disposed on one side of the second substrate 112 facing toward the cholesteric liquid crystal layer 113. As shown in FIG. 2B, the first transparent electroconductive layer 114 of this embodiment is comprehensively disposed on the surface of the first substrate 111 facing toward the cholesteric liquid crystal layer 113, and the second transparent electroconductive layer 115 is comprehensively disposed on one side of the second substrate 112 facing toward the cholesteric liquid crystal layer 113. Herein, the “comprehensively” means that the first transparent electroconductive layer 114 comprises a whole electrode (common electrode), which fully covers most of the surface of the first substrate 111 facing toward the cholesteric liquid crystal layer 113, and the second transparent electroconductive layer 115 also comprises a whole electrode, which fully covers one side of the second substrate 112 facing toward the cholesteric liquid crystal layer 113. Alternatively, in different embodiments, as shown in FIG. 2E, the second transparent electroconductive layer 115 may comprise a plurality of electrode blocks 1151, which are respectively disposed in correspondence with the photo-sensing dot-areas 121 or the photo-sensing elements 1211 arranged in an array. However, the present invention is not limited thereto.

By controlling the voltage difference between the first transparent electroconductive layer 114 and the second transparent electroconductive layer 115, the orientating state of the cholesteric liquid crystal molecules may be controlled. In addition, the cholesteric liquid crystal device 11 may further comprise a sealing layer (not shown). The sealing layer is disposed between the first substrate 111 and the second substrate 112, and seals the outer peripheries of the first substrate 111 and the second substrate 112, so that a gap d is formed between the first substrate 111 and the second substrate 112. A chamber may be formed by the first substrate 111, the second substrate 112 and the sealing layer, so that the cholesteric liquid crystal molecules may be filled into the chamber to form the cholesteric liquid crystal layer 113. It is noted that in this embodiment, the light-entering surface D1 of the cholesteric liquid crystal device 11 refers to the upper surface of the first substrate 111 which is disposed opposite to (or away from) the cholesteric liquid crystal layer 113, and the light-emitting surface D2 refers to the lower surface of the second substrate 112 which is disposed opposite to (or away from) the cholesteric liquid crystal layer 113. Alternatively, the light-entering surface D1 may refer to the upper surface of the cholesteric liquid crystal layer 113 facing toward the first substrate 111, and the light-emitting surface D2 may refer to the lower surface of the cholesteric liquid crystal layer 113 facing toward the second substrate 112, or any combination of the preceding examples, and the present invention is not limited thereto.

In this embodiment, the first substrate 111 and the second substrate 112 may individually comprise a transparent substrate, and may be a flexible transparent substrate or a rigid transparent substrate. The material of the flexible transparent substrate comprises, for example but without limiting to, polyimide (PI), polycarbonate (PC) or polyethylene terephthalate (PET). The material of the rigid transparent substrate comprises, for example but without limiting to, glass, quartz or sapphire. If the first substrate 111 and the second substrate 112 are both made of the flexible transparent material(s), then the cholesteric liquid crystal writing board 1 may be made into a curved display because such transparent substrate is flexible. In addition, the first transparent electroconductive layer 114 and the second transparent electroconductive layer 115 may be, for example but without limiting to, indium tin oxide (ITO) or indium zinc oxide (IZO), and the present invention is not limited thereto.

The cholesteric liquid crystal device 11 may display a color correspondingly. In details, the cholesteric liquid crystal device 11 may be prepared to show colors, such as red (R), green (G), or blue (B) and the like, by adding various chiral dopants with different contents. Herein, the color correspondingly displayed by the cholesteric liquid crystal device 11 may be selected from, for example but without limiting to, either red, green, blue, or other color of visible light. The specific orientation of the cholesteric liquid crystal molecules is achieved by adding chiral dopants to the nematic liquid crystal molecules. The display function is achieved by using cholesteric liquid crystal molecules which may exhibit various stable states and transient states, such as at least a focal conic state, a planar state and a homeotropic state, and the like, under various voltages, physical pressures and/or temperatures. Hence, by changing the axial orientation of the helical structure of the cholesteric liquid crystal molecules, a portion of the incident light is reflected and/or a portion of the light may pass through the cholesteric liquid crystal layer 113. In other words, the display function of the cholesteric liquid crystal device 11 may be achieved with the different optical reflectance or transmittance possessed by the cholesteric liquid crystal molecules at different stable states or transient states.

Hereinafter, the structure of the photo-sensing array layer 12 of the cholesteric liquid crystal writing board 1 of this embodiment will be described.

FIG. 2C is a schematic diagram showing the equivalent circuit of the light-sensing dot-area 121 of the photo-sensing array layer 12 of the cholesteric liquid crystal writing board 1 of FIG. 2A. Referring to FIG. 2C of this embodiment, the photo-sensing array layer 12 may further comprise a plurality of upload-lines UPn and a plurality of read-lines Rm and Rm+1. The upload-lines UPn are crossed with the read-lines Rm and Rm+1 so as to define a plurality of photo-sensing dot-areas 121. The sensing-signal processing circuitry C is coupled to the photo-sensing array layer 12 (see FIG. 2B). Herein, FIG. 2C shows two adjacent photo-sensing dot-areas 121.

In FIG. 2C, each of the photo-sensing dot-areas 121 may comprise a photo-sensing element 1211 and a switch element 1212. A control terminal of the switch element 1212 is connected to one of the upload-lines UPn. A first terminal of the switch element 1212 is connected to one of the read-lines Rm and Rm+1. A second terminal of the switch element 1212 is connected to one terminal of the photo-sensing element 1211, and another terminal of the photo-sensing element 1211 is coupled to a reference voltage Vref. The reference voltage Vref may be, for example but without limiting to, a common voltage (Vcom), a gate voltage (Vgate) or a grounding voltage (Vgnd) or the like, according to practical requirements. The switch element 1212 and the photo-sensing element 1211 are coupled to the sensing-signal processing circuitry C through the read-lines Rm and Rm+1. Herein, the switch element 1212 may be, for example, a thin film transistor, and the photo-sensing element 1211 may be made using the same process and material as the switch element 1212 to save costs. However, the sensing-signal processing circuitry C may be implemented by way of, for example but without limiting to, an integrated circuit or a microchip or other ways. In other embodiments, the photo-sensing element 1211 may also be a photosensitive element, such as a microchip of a photodiode. The detection is carried out by obtaining difference(s) of the various photoelectric currents caused by the luminous flux change generated upon the photo-sensing element 1211 being irradiated by the light or not, or irradiated with various irradiation amounts/intensities.

In details, when the switch element 1212 on the left side of FIG. 2C is taken as an example, a gate of the switch element 1212 (thin film transistor) is connected/coupled to the upload line UPn, a first terminal (source) thereof is connected/coupled to the read line Rm, a second terminal (drain) thereof is connected/coupled to one terminal of the photo-sensing element 1211, and another terminal of the photo-sensing element 1211 may be connected/coupled to a common voltage (Vcom), such as the ground. Hence, when a signal transmitted via the upload line UPn turns on the switch element 1212, the sensing-signal processing circuitry C coupled thereto can receive the sensing signal generated by the photo-sensing element 1211 due to the luminous flux change through the read-line Rm and the switch element 1212, and outputs the position data Dp according to the received sensing signal. The position data Dp comprises the position (or coordinate) information about where the said photo-sensing element 1211 (i.e. the photo-sensing element 1211 which generates such photoelectrical current/sensing signal) locates in the photo-sensing array layer 12.

Hereinafter, it is to describe how the cholesteric liquid crystal writing board 1 obtains the occurrence position of a morphological change of the cholesteric crystal molecules (or the luminous flux change of the photo-sensing element 1211) when the morphological change is occurred due to changing of the orientating state of the cholesteric liquid crystal molecules in the cholesteric liquid crystal device 11.

Please refer again to FIG. 1 and through FIG. 2A to FIG. 2D. In the cholesteric liquid crystal writing board 1 of this embodiment, when the cholesteric liquid crystal device 11 is not pressed and is not supplied with the power, the cholesteric liquid crystal molecules of the cholesteric liquid crystal layer 113 are orientated in a focal conic state. At this time, most of the incident light L1 may pass through the cholesteric liquid crystal layer 113, and a small portion of the incident light L1 is scattered. Hence, the user can see the background color of the cholesteric liquid crystal writing board 1, such as black, at this time.

When the user writes on the cholesteric liquid crystal writing board 1 with a stylus P (or a finger or other solid objects) to press the cholesteric liquid crystal device 11, the gap d between the first substrate 111 and the second substrate 112 becomes smaller at this time, and the orientation of the cholesteric liquid crystal molecules in corresponding portion (i.e. the pressed part) of the cholesteric liquid crystal layer 113 are morphologically changed from the original focal conic state to the planar state. At this time, partial of the incident light L2 has a Bragg reflection occurred at the pressed position (i.e. the central dent of the first substrate 111 depicted in FIG. 2D), and the reflected light Lr (with a certain wavelength) is emitted from the light-entering surface D1. In the meantime, the cholesteric liquid crystal device 11 displays the color (e.g., green) of the reflected light Lr at the pressed position. Hence, if the user writes a letter, a character, or a word, or draws a figure with the stylus P (or a finger or other solid objects) on the cholesteric liquid crystal writing board 1 to generate a writing track S on the cholesteric liquid crystal device 11, then the writing track S renders the color corresponding to the reflected light Lr.

As mentioned above and as shown in FIG. 2C and FIG. 2D, when there is no portion pressed on the light-entering surface D1 of the cholesteric liquid crystal device 11 or the central portion of the light-entering surface D1 is not pressed, the orientation of the cholesteric liquid crystal molecules in this portion of the cholesteric liquid crystal layer 113 are stayed in the focal conic state. Hence, most of the light (e.g., the incident light L1) incident to this portion may pass through the cholesteric liquid crystal layer 113 and is transmitted to the photo-sensing dot-area 121. The photo-sensing element 1211 in the photo-sensing dot-area 121 can sense the incident light L1 and a first luminous flux is obtained. When the user presses the cholesteric liquid crystal writing board 1, the orientation of at least a portion of the cholesteric liquid crystal molecules in the cholesteric liquid crystal layer 113 corresponding to the pressed position (i.e. the central dent of the light-entering surface D1 in FIG. 2D) will be morphologically changed from the focal conic state to the planar state. At this time, as previously mentioned, partial of the light L2 (i.e., the reflected light Lr) incident to the pressed position is reflected by the cholesteric liquid crystal molecules which are in the planar state and emitted from the light-entering surface D1, and the remaining part of the light L2′ may pass through the cholesteric liquid crystal layer 113 and is transmitted to the photo-sensing element 1211 in the corresponding photo-sensing dot-area 121. At this time, the corresponding photo-sensing element 1211 may sense the light L2′ and a second luminous flux is obtained. And, the difference between the first luminous flux and the second luminous flux is the luminous flux change sensed by the photo-sensing element 1211 in the light-sensing point 121. Accordingly, the sensing-signal processing circuitry C coupled to the read-lines Rm and Rm+1 receives (or “reads”), via the read-lines Rm and Rm+1, electrical signals (i.e., “sensing signals”) corresponding to different voltage values generated by each of the photo-sensing elements 1211 sensing the luminous fluxes with various intensities. When the sensing-signal processing circuitry C receives this sensing signal(s), it is obtained that which one, or ones, of the photo-sensing elements 1211 transmit this sensing signal(s). The sensing-signal processing circuitry C can output the position data Dp to another control unit or processing unit (not shown) according to this sensing signal, and the position data Dp represents or corresponds to the position where said the aforementioned one or more of the photo-sensing element 1211 which sense(s) this luminous flux change locate(s) in the photo-sensing array layer 12 (e.g., at which column and row said photo-sensing element(s) 1211 locate(s) in the photo-sensing array layer 12). The above-mentioned position data Dp corresponds to or represents the positions where the photo-sensing element(s) 1211 which sense(s) this luminous flux change locate(s) in the photo-sensing array layer 12. Thereby, the cholesteric liquid crystal writing board 1 can detect the pressed (or written) position on the cholesteric liquid crystal writing board 1.

In addition, the sensing signals read by the read-lines Rm and Rm+1 can be transmitted to another electronic device when the upload-lines UPn turn on. Alternatively, the sensing signals read by the read-lines Rm and Rm+1 may be transmitted to another electronic device in a blanking time after the upload-lines UPn turn on. In other words, the read sensing signals may be transmitted to another electronic device while the upload-lines UPn sequentially turn on. Alternatively, all sensing signals may be transmitted once(non-immediately) in the blanking time after all upload-lines UPn have turned on and before the next time that they are turned on, and the present invention is not limited thereto.

Referring again to FIG. 2B, the cholesteric liquid crystal device 11 of this embodiment further comprises an insulating layer 117, and the second transparent electroconductive layer 115, the insulating layer 117 and the photo-sensing array layer 12 are sequentially stacked on a surface of the second substrate 112 facing toward the cholesteric liquid crystal layer 113.

In addition, as shown in FIG. 2A, FIG. 2B and FIG. 2D, the cholesteric liquid crystal writing board 1 of this embodiment may further comprise a backing plate 13 disposed on one side of the second substrate 112 facing toward the light-emitting surface D2. Herein, the backing plate 13 may be a black light-absorbing plate or a white light-reflecting plate. When the backing plate 13 is the black light-absorbing plate, it absorbs the light that passes through the cholesteric liquid crystal device 11 and makes the cholesteric liquid crystal writing board 1 become a blackboard. In some embodiments, the material of the black light-absorbing plate may be the same as the material of the black matrix of the liquid crystal display device. In addition, when the backing plate 13 is a white light-reflecting plate, it reflects the light that passes through the cholesteric liquid crystal device 11 and makes the cholesteric liquid crystal writing board 1 become a whiteboard. In some embodiments, the material of the white light reflective plate may comprise, for example, metal, metal oxide, a highly reflective paint (white paint) or a combination thereof, and the present invention is not limited thereto. Alternatively, in different embodiments, the color of the reflective plate is also not limited to white, and may be one of other colors or a combination of multiple colors.

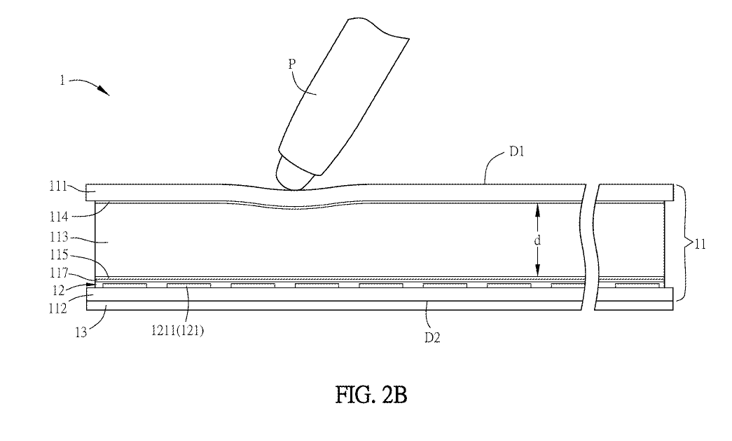

Referring to FIG. 3, a cholesteric liquid crystal writing board 1a of this embodiment and the cholesteric liquid crystal writing board 1 of the foregoing embodiment are substantially the same in the composition and the connection relationship of the components. The difference is that the cholesteric liquid crystal writing board 1a of this embodiment does not comprise the insulating layer 117, the second transparent electroconductive layer 115 is disposed on the surface of the second substrate 112 facing toward the cholesteric liquid crystal layer 113, and the photo-sensing array layer 12 is disposed on the surface of the second substrate 112 opposite to (or away from) the cholesteric liquid crystal layer 113 in a back-to-back manner and is therefore located between the second substrate 112 and the backing plate 13.

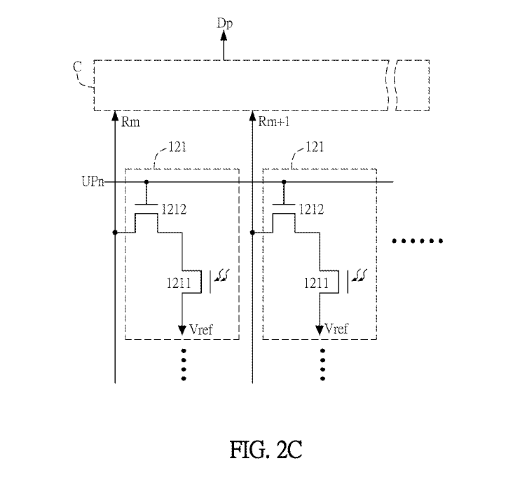

Referring to FIG. 4, which is a structural schematic view showing another embodiment of the cholesteric liquid crystal writing board of this disclosure. A cholesteric liquid crystal writing board 1b of this embodiment and the cholesteric liquid crystal writing board 1 of the foregoing embodiment are also substantially the same in the composition and the connection relationship of the components. The difference is that, in the cholesteric liquid crystal writing board 1b of this embodiment, the photo-sensing array layer 12 further comprises a third substrate 120, and the photo-sensing elements 1211 arranged in an array are disposed on a surface of the third substrate 120 facing toward the second substrate 112. The photo-sensing array layer 12 is disposed on one side of the second substrate 112 opposite to (or away from) the cholesteric liquid crystal layer 113. The photo-sensing array layer 12 is disposed outside the cholesteric liquid crystal device 11, and is located on the side of the light-emitting surface D2 of the cholesteric liquid crystal device 11. In this embodiment, the applicable material for the third substrate 120 may be the same as those can used in the first substrate 111 and the second substrate 112 of the cholesteric liquid crystal writing board 1 in the foregoing embodiment, and may be a flexible transparent material or a rigid transparent material.

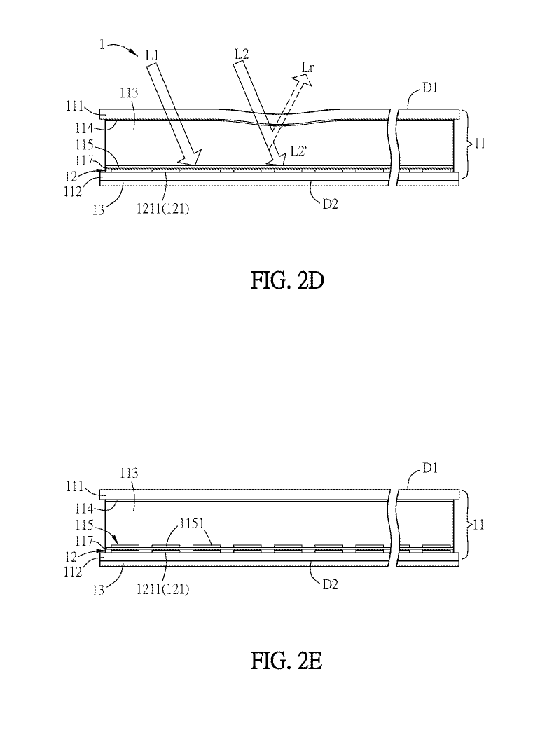

As shown in FIG. 5, which is a structural schematic view showing still another embodiment of the cholesteric liquid crystal writing board of this disclosure. A cholesteric liquid crystal writing board 1c of this embodiment and the cholesteric liquid crystal writing board 1 of the foregoing embodiment are also substantially the same in the composition and the connection relationship of the components. The difference is that the backing plate 13 is not provided in a cholesteric liquid crystal writing board 1c of this embodiment. The first substrate 111 is still a transparent substrate, but the second substrate 112c is a black light-absorbing substrate or a white light-reflecting substrate. In this embodiment, the second substrate 112c also has both functions of the second substrate 112 and the backing plate 13 in the foregoing embodiment.

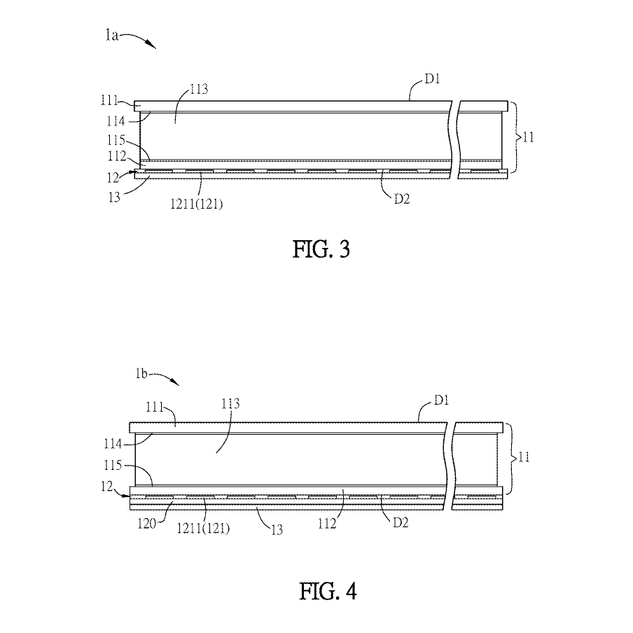

As shown in FIG. 6, which is a structural schematic view showing yet still another embodiment of the cholesteric liquid crystal writing board of this disclosure. A cholesteric liquid crystal writing board 1d of this embodiment and the cholesteric liquid crystal writing board 1 of the foregoing embodiment are also substantially the same in the composition and the connection relationship of the components. The difference is that the backing plate 13 is also not provided in a cholesteric liquid crystal writing board 1d of this embodiment. A photo-sensing array layer 12d further comprises a third substrate 120d, the photo-sensing elements 1211 arranged in an array are disposed on a surface of the third substrate 120d facing toward the second substrate 112, and the photo-sensing array layer 12d is disposed on one side of the second substrate 112 opposite to (or away from) the cholesteric liquid crystal layer 113. In other words, the photo-sensing array layer 12d is disposed outside the cholesteric liquid crystal device 11, and is located on one side of the cholesteric liquid crystal device 11 facing toward the light-emitting surface D2. Meanwhile, the first substrate 111 and the second substrate 112 are still transparent substrates, but the third substrate 120d is a black light-absorbing plate or a white light-reflecting plate, or a plate of other colors. In other words, in this embodiment, the third substrate 120d also has both functions of the third substrate 120 and the backplane 13 in the foregoing embodiment. Because the photo-sensing array layer 12d is disposed outside the cholesteric liquid crystal device 11, no insulating layer is provided on the second substrate 112.

In addition, in the above-mentioned cholesteric liquid crystal writing board 1, 1a, 1b, 1c or 1d, if a holding voltage is applied between the first transparent electroconductive layer 114 and the second transparent electroconductive layer 115 of the cholesteric liquid crystal device 11, then the cholesteric liquid crystal molecules of the cholesteric liquid crystal device 11 cannot transform into a planar state and the cholesteric liquid crystal writing board 1 cannot display its corresponding color even if the user presses the cholesteric liquid crystal device 11. In some embodiments, the holding voltage may range from 0V to 4.5V, or range from 35.4V to 47.6V. Alternatively, the holding voltage may range from 0V to 3.7V, or range from 29V to 39V. Moreover, the holding voltage may also range from 0V to 3.1V, or range from 24.5V to 33V. It is noted that the above-mentioned 4.5V, 3.7 or 3.1V may be a state-changing voltage at which the cholesteric liquid crystal molecules of the cholesteric liquid crystal device 11 are driven to the focal conic state (non-display state) from the planar alignment structure (planar state, display state). The above-mentioned 35.4V, 29V or 24.5V may be the state-changing voltage at which the cholesteric liquid crystal molecules of the cholesteric liquid crystal device 11 are transformed into the vertical alignment structure (homeotropic state) from the planar alignment structure (planar state). The above-mentioned 47.6V, 39V or 33V may be the state-changing voltage at which the cholesteric liquid crystal molecules of the cholesteric liquid crystal device 11 are transformed into the vertical alignment structure (homeotropic state) from the vertical focal conic arrangement structure.

Moreover, when an erasing voltage which is higher than the holding voltage is applied between the first transparent electroconductive layer 114 and the second transparent electroconductive layer 115 of the cholesteric liquid crystal device 11, then a writing track S can be erased if the color writing track S has been displayed on the cholesteric liquid crystal writing board 1. The erasing voltage makes the cholesteric liquid crystal molecules of the cholesteric liquid crystal device 11 to be morphologically changed into the focal conic state from the homeotropic state, so that the images displayed on the cholesteric liquid crystal writing board 1 is completely erased and cleared. The cholesteric liquid crystal writing board 1 then renders its background color. In some embodiments, the erasing voltage comprises, for example but without limiting to, 70V, 60V or 55V. In some embodiments, the holding voltage or the erasing voltage may be applied to the cholesteric liquid crystal device 11, for example, through pressing a physical or virtual key, so as to achieve the function of holding or erasing the image(s).

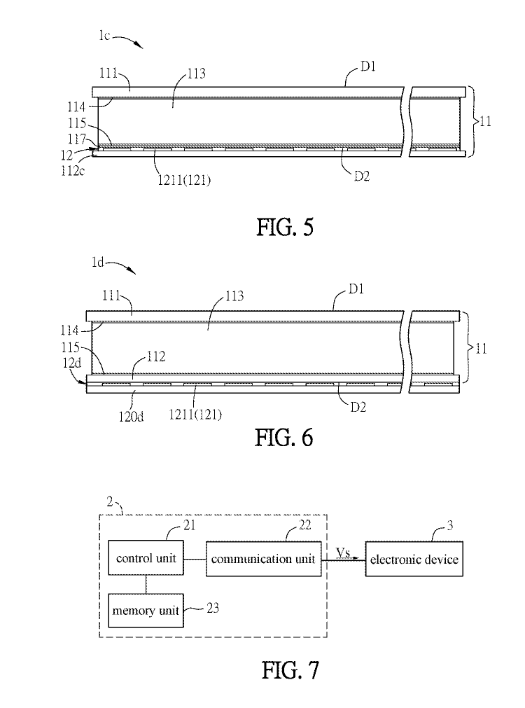

FIG. 7 is a functional block diagram showing an embodiment of the cholesteric liquid crystal writing board and an electronic device of the present disclosure. As shown in FIG. 7, a cholesteric liquid crystal writing board 2 may communicate with an electronic device 3. The cholesteric liquid crystal writing board 2 of this embodiment may comprise the above-mentioned cholesteric liquid crystal writing board 1, 1a, 1b, 1c or 1d, or its modified aspect(s). The specific techniques have been described hereinabove, and the details are omitted. In addition, the electronic device 3 may be, for example but without limiting to, another cholesteric liquid crystal writing board, or a mobile phone, a tablet, a notebook computer, or other display devices.

In addition, the cholesteric liquid crystal writing board 2 of this embodiment may further comprise a control unit 21, a communication unit 22 and a memory unit 23. The communication unit 22 is electrically connected/coupled to the control unit 21, and the cholesteric liquid crystal writing board 2 may be communicatively linked with the electronic device 3 via the communication unit 22. In order to achieve the communicative linkage, the electronic device 3 have a corresponding communication unit with the cholesteric liquid crystal writing board 2 in order to achieve the communicative linkage therebetween. The communication unit 22 may be a wireless communication module or a wired communication module, and the wireless communication module may be selected from the group consisting of a Wi-Fi module, a bluetooth module, a telecommunication communication module (such as 3G or 4G) and a combination thereof. In addition, the memory unit 23 is electrically connected/coupled to the control unit 21, and the memory unit 23 may store a sensing signal Vs generated by the photo-sensing array layer 12. Hence, the control unit 21 can transmit the sensing signal Vs, which is generated by pressing the cholesteric liquid crystal writing board 2 and stored in the memory unit 23, to the electronic device 3 through the corresponding communication unit 22, so that the electronic device 3 can obtain the position and/or color of the writing track S (as shown in FIG. 1) on the cholesteric liquid crystal writing board 2. Thereby, the application of the cholesteric liquid crystal writing board 2 is expanded. For example, if a corresponding application software is installed on the electronic device 3 and the cholesteric liquid crystal writing board 2, which communicate with each other, then when the user writes or presses on the cholesteric liquid crystal writing board 2 to generate a pressing or writing track, the electronic device 3 may display the same pressing or writing track and color correspondingly. In this way, the cholesteric liquid crystal writing board 2 can be made to interact with the electronic device 3. Therefore, the cholesteric liquid crystal writing board 2 can be used in, an interactive writing systems, such as teaching or meetings, so as to achieve the advantages and effects of low-cost and simultaneously interaction.

In summary, in the cholesteric liquid crystal writing board of the present disclosure, the cholesteric liquid crystal device has the cholesteric liquid crystal layer, and the photo-sensing array layer comprises a plurality of photo-sensing elements arranged in an array and is disposed on one side of the light-emitting surface of the cholesteric liquid crystal device. When at least a portion of the cholesteric liquid crystal layer is morphologically changed due to a pressure caused by a press to generate a luminous flux change, one of the photo-sensing elements of the photo-sensing array layer will sense the luminous flux change and generate a sensing signal accordingly. The sensing-signal processing circuitry is coupled to the photo-sensing array layer, receives the sensing signal and accordingly outputs position data of the light-sensing element in the photo-sensing array layer. Hence, the cholesteric liquid crystal writing board of the present disclosure utilizes the property of the cholesteric liquid crystal. In addition to the achieving the objective of energy-saving, the writing position is also possible to be acquired, such that the application of the cholesteric liquid crystal writing board is expanded. For example, it can be used in the interactive writing systems used in, for example, meetings and classrooms for teaching, so as to achieve the effects of low-cost and simultaneously interaction.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A cholesteric liquid crystal writing board, comprising:
a cholesteric liquid crystal device comprising a cholesteric liquid crystal layer and having a light-entering surface and a light-emitting surface opposite to the light-entering surface;
a photo-sensing array layer, which comprises a plurality of photo-sensing elements arranged in an array, and is disposed on one side of the light-emitting surface of the cholesteric liquid crystal device, wherein when at least a portion of the cholesteric liquid crystal layer is morphologically changed due to a pressure caused by a press to generate a luminous flux change, one of the photo-sensing elements of the photo-sensing array layer senses the luminous flux change and generates a sensing signal accordingly; and
a sensing-signal processing circuitry coupled to the photo-sensing array layer, wherein the sensing-signal processing circuitry receives the sensing signal and accordingly outputs position data of the light-sensing element in the photo-sensing array layer.

2. The cholesteric liquid crystal writing board according to claim 1, wherein the cholesteric liquid crystal device further comprises a first substrate and a second substrate opposite to the first substrate, the cholesteric liquid crystal layer is disposed between the first substrate and the second substrate, the cholesteric liquid crystal device further comprises a first transparent electroconductive layer disposed on a surface of the first substrate facing toward the cholesteric liquid crystal layer, and the cholesteric liquid crystal device further comprises a second transparent electroconductive layer disposed on one side of the second substrate facing toward the cholesteric liquid crystal layer.

3. The cholesteric liquid crystal writing board according to claim 2, wherein the second transparent electroconductive layer is comprehensively disposed on the one side of the second substrate facing toward the cholesteric liquid crystal layer.

4. The cholesteric liquid crystal writing board according to claim 2, wherein the second transparent electroconductive layer comprises a plurality of electrode blocks respectively disposed in correspondence with the photo-sensing elements which are arranged in the array.

5. The cholesteric liquid crystal writing board according to claim 2, wherein the cholesteric liquid crystal device further comprises an insulating layer, and the second transparent electroconductive layer, the insulating layer and the photo-sensing array layer are sequentially stacked on a surface of the second substrate facing toward the cholesteric liquid crystal layer.

6. The cholesteric liquid crystal writing board according to claim 2, wherein the photo-sensing array layer is disposed on a surface of the second substrate opposite to the cholesteric liquid crystal layer in a back-to-back manner.

7. The cholesteric liquid crystal writing board according to claim 2, wherein the photo-sensing array layer is disposed on one side of the second substrate opposite to the cholesteric liquid crystal layer, the photo-sensing array layer comprises a third substrate, and the photo-sensing elements which are arranged in the array are disposed on a surface of the third substrate facing toward the second substrate.

8. The cholesteric liquid crystal writing board according to claim 2, further comprising:
a backing plate, which is disposed on one side of the second substrate facing toward the light-emitting surface, and is a light-absorbing plate.

9. The cholesteric liquid crystal writing board according to claim 2, further comprising:
a backing plate, which is disposed on one side of the second substrate facing toward the light-emitting surface, and is a light-reflecting plate.

10. The cholesteric liquid crystal writing board according to claim 2, wherein the first substrate is a transparent substrate, and the second substrate is a light-absorbing substrate.

11. The cholesteric liquid crystal writing board according to claim 2, wherein the first substrate is a transparent substrate, and the second substrate is a light-reflecting substrate.

12. The cholesteric liquid crystal writing board according to claim 7, wherein each of the first substrate and the second substrate is a transparent substrate, and the third substrate is a light-absorbing substrate.

13. The cholesteric liquid crystal writing board according to claim 7, wherein each of the first substrate and the second substrate is a transparent substrate, and the third substrate is a light-reflecting plate.

14. The cholesteric liquid crystal writing board according to claim 1, wherein the photo-sensing array layer further comprises:
a plurality of upload-lines and a plurality of read-lines which are disposed crossed to the upload-lines to define a plurality of photo-sensing dot-areas, wherein each of the photo-sensing dot-areas comprises a switch element and one of the photo-sensing elements, a control terminal of the switch element is connected to one of the upload-lines, a first terminal of the switch element is connected to one of the read-lines, a second terminal of the switch element is connected to one terminal of said photo-sensing element, and the other terminal of the photo-sensing element is connected to a reference voltage.

15. The cholesteric liquid crystal writing board according to claim 14, wherein the sensing signal is transmitted to another electronic device when the upload-lines are turned on.

16. The cholesteric liquid crystal writing board according to claim 14, wherein the sensing signal is transmitted to another electronic device in a blanking time after the upload-lines are turned on.

17. The cholesteric liquid crystal writing board according to claim 1, further comprising:
a control unit;
a communication unit electrically connected to the control unit, wherein the cholesteric liquid crystal writing board communicates and links with an electronic device through the communication unit; and
a memory unit, which is electrically connected to the control unit and stores the sensing signal.

18. The cholesteric liquid crystal writing board according to claim 1, wherein when the cholesteric liquid crystal device is pressed, the at least one portion of the cholesteric liquid crystal layer is morphologically changed from a focal conic state to a planar state.

19. The cholesteric liquid crystal writing board according to claim 18, wherein the cholesteric liquid crystal device is pressed to generate a writing track, and the writing track renders a color corresponding to the cholesteric liquid crystal device.

20. The cholesteric liquid crystal writing board according to claim 1, wherein the position data comprises a position information concerning where the cholesteric liquid crystal device is pressed.
